(19) United States
(12) Patent Application Publication
(10) Pub. No.: US 2011/0187663 A1
(43) Pub. Date: Aug. 4, 2011

(54) OBJECT SENSING APPARATUS, TOUCH SENSING SYSTEM, AND TOUCH SENSING METHOD

(75) Inventors: Ching-Chun Lin, Taipei County (TW); Wing-Kai Tang, Hsinchu City (TW); Ching-Ho Hung, Hsinchu City (TW); Tsen-Wei Chang, Taichung County (TW); Yi-Liang Lin, Hsinchu County (TW); Jiun-Jie Tsai, Hsinchu City (TW)

(73) Assignee: NOVATEK MICROELECTRONICS CORP., Hsinchu (TW)

(21) Appl. No.: 13/018,425

(22) Filed: Feb. 1, 2011

(30) Foreign Application Priority Data
Feb. 2, 2010 (TW) 99103025

(51) Int. Cl. G06F 3/041

(52) U.S. Cl. 345/173

(57) ABSTRACT

An object sensing apparatus including an object sensing unit, a signal selecting unit, at least one signal sensing unit, and a control unit is provided. The object sensing unit outputs a plurality of sensing signals. The signal selecting unit selects at least one of the sensing signals as a signal under test and selects at least one of the unselected sensing signals as a reference signal. The signal sensing unit outputs a difference signal according to the signal under test and the reference signal. The control unit determines an object position relative to the object sensing unit according to the difference signal. Additionally, a touch sensing apparatus and a method thereof are also provided.

### CROSS-REFERENCE TO RELATED APPLICATION

This application claims the priority benefit of Taiwan application serial no. 99103025, filed on Feb. 2, 2010. The entirety of the above-mentioned patent application is hereby incorporated by reference herein and made a part of this specification.

### BACKGROUND OF THE INVENTION

1. Field of the Invention

The invention generally relates to a sensing apparatus and a method thereof, and more particularly, to an object sensing apparatus and a method thereof.

2. Description of Related Art

In this information era, reliance on electronic products is increasing day by day. The electronic products including notebook computers, mobile phones, personal digital assistants (PDAs), digital walkmans, and so on are indispensable in our daily lives. Each of the aforesaid electronic products has an input interface for a user to input his or her command, such that an internal system of each of the electronic product spontaneously runs the command. At this current stage, the most common input interface includes a keyboard and a mouse.

From the user's aspect, it is sometimes rather inconvenient to use the conventional input interface including the keyboard and the mouse. Manufacturers aiming to resolve said issue thus start to equip the electronic products with touch input interfaces, e.g. touch pads or touch panels, so as to replace the conditional keyboards and mice. At present, the users' commands are frequently given to the electronic products by physical contact or sensing relationship between users' fingers or styluses and the touch input interfaces. For instance, a capacitive touch input interface characterized by a multi-touch sensing function is more user-friendly than the conventional input interface and thus gradually becomes more and more popular.

However, given that the capacitive touch input interface is applied to a one-end sensing circuit, capacitance of a capacitor under test is required to be measured and stored as a base line capacitance before touch sensing. The base line capacitance is subtracted from the capacitance under test which is measured by the one-end sensing circuit, and thereby the capacitance variations of the capacitor under test can be obtained. Meanwhile, a reference capacitance of the capacitor under test measured by the one-end sensing circuit has a fixed value so that external noises cannot be effectively reduced and accordingly the noise-to-signal ratio (NSR) of the one-end sensing circuit cannot be effectively enhanced.

### SUMMARY OF THE INVENTION

Accordingly, the invention is directed to an object sensing apparatus capable of dynamically selecting the reference capacitance so that the noise-to-signal ratio (NSR) of the object sensing apparatus is effectively enhanced.

The invention is also directed to a touch sensing system capable of dynamically selecting the reference capacitance so that the NSR of the touch sensing system is effectively enhanced.

The invention is further directed to a touch sensing method capable of dynamically selecting the reference capacitance so that the NSR of a touch sensing system is effectively enhanced.

The invention provides an object sensing apparatus including an object sensing unit, a signal selecting unit, at least one signal sensing unit, and a control unit. The object sensing unit outputs a plurality of sensing signals. The signal selecting unit selects at least one of the sensing signals as a signal under test and selects at least one of the unselected sensing signals as a reference signal. The signal sensing unit outputs a difference signal according to the signal under test and the reference signal. The control unit determines an object position relative to the object sensing unit according to the difference signal.

According to an embodiment of the invention, the control unit includes an analog-to-digital converter (ADC) and a controller. The ADC converts the difference signal into a digital signal. The controller determines the object position relative to the object sensing unit according to the digital signal.

According to an embodiment of the invention, the signal selecting unit respectively selects at least two different sensing signals from the unselected sensing signals as the reference signal during a first sensing period and a second sensing period.

According to an embodiment of the invention, the number of the sensing signals is P. The signal selecting unit selects the N^{th} sensing signal as the signal under test and selects the (N+K)^{th} and the (N−K)^{th} sensing signals as the reference signals, wherein P, N, and K are positive integers, 1<N<P, 3≦K+N≦P, and 1≦K−N≦(P−2).

According to an embodiment of the invention, the signal selecting unit selects at least two of the sensing signals as the signal under tests and at least two of the unselected sensing signals as the reference signals, and each signal sensing unit receives the corresponding signal under test and the corresponding reference signal to output the corresponding difference signal.

According to an embodiment of the invention, the corresponding signal under test received by each signal sensing unit is different from the corresponding signal under tests received by other signal sensing units.

According to an embodiment of the invention, each signal sensing unit receives the same corresponding signal under test during a first sensing period and a second sensing period.

According to an embodiment of the invention, each signal sensing unit receives different reference signals during the first sensing period and the second sensing period.

According to an embodiment of the invention, the control unit receives a plurality of difference signals and determines the object position relative to the object sensing unit according to the received difference signals.

According to an embodiment of the invention, the control unit includes a plurality of ADCs and a controller. Each of the ADCs receives the corresponding difference signal and converts it into a corresponding digital signal. The controller receives a plurality of digital signals and detellnines the object position relative to the object sensing unit according to the received digital signals.

According to an embodiment of the invention, the object sensing apparatus further includes a driving unit for driving the object sensing unit to output the sensing signals.

The invention provides a touch sensing system including a touch input interface, a signal selecting unit, at least one signal sensing unit, and a control unit. The touch input interface includes a plurality of touch sensors for outputting a plurality of sensing signals according to a touch gesture. The signal selecting unit selects at least one of the sensing signals as a signal under test and selects at least one of the unselected sensing signals as a reference signal. The signal sensing unit outputs a difference signal according to the signal under test and the reference signal. The control unit determines the position of the touch gesture on the touch input interface according to the difference signal.

According to an embodiment of the invention, the control unit includes an ADC and a controller. The ADC converts the difference signal into a digital signal. The controller determines the position of the touch gesture on the touch input interface according to the digital signal.

According to an embodiment of the invention, the signal selecting unit respectively selects at least two different sensing signals from the unselected sensing signals as the reference signal during a first sensing period and a second sensing period

According to an embodiment of the invention, the number of the sensing signals is P. The signal selecting unit selects the N^{th} sensing signal as the signal under test and selects the (N+K)^{th} and the (N−K)^{th} sensing signals as the reference signals, wherein P, N, and K are positive integers, 1<N<P, 3≦K+N≦P, and 1≦K−N≦(P−2).

According to an embodiment of the invention, the signal selecting unit selects at least two of the sensing signals as the signal under tests and at least two of the unselected sensing signals as the reference signals, and each signal sensing unit receives the corresponding signal under test and the corresponding reference signal to output the corresponding difference signal.

According to an embodiment of the invention, the corresponding signal under test received by each signal sensing unit is different from the corresponding signal under tests received by other signal sensing units.

According to an embodiment of the invention, each signal sensing unit receives the same corresponding signal under test during a first sensing period and a second sensing period.

According to an embodiment of the invention, each signal sensing unit receives different reference signals during the first sensing period and the second sensing period.

According to an embodiment of the invention, the control unit receives a plurality of difference signals and determines the position of the touch gesture on the touch input interface according to the received difference signals.

According to an embodiment of the invention, the control unit includes a plurality of ADCs and a controller. Each of the ADCs receives the corresponding difference signal and converts it into a corresponding digital signal. The controller receives a plurality of digital signals and determines the position of the touch gesture on the touch input interface according to the received digital signals.

According to an embodiment of the invention, the touch sensing system further includes a driving unit for driving the touch sensors to output the sensing signals.

The invention provides a touch sensing method adaptable to a touch sensing system, wherein the touch sensing system includes a touch input interface. The touch sensing method includes following steps. A plurality of sensing signals is generated according to a touch gesture. At least one of the sensing signals is selected as a signal under test. At least one of the unselected sensing signals is selected as a reference signal. A difference signal is generated according to the signal under test and the reference signal. The position of a touch gesture on the touch input interface is determined according to the difference signal.

According to an embodiment of the invention, the touch sensing method further includes following steps. The difference signal is converted into a digital signal. The position of the touch gesture on the touch input interface is determined according to the digital signal.

According to an embodiment of the invention, in the step of selecting the reference signal, at least two different sensing signals are selected from the unselected sensing signals respectively during a first sensing period and a second sensing period as the reference signal.

According to an embodiment of the invention, the number of the sensing signals is P. In the step of selecting the signal under test, the N^{th} sensing signal is selected as the signal under test. In the step of selecting the reference signal, the (N+K)^{th} and the (N−K)^{th} sensing signals are selected as the reference signals, wherein P, N, and K are positive integers, 1<N<P, 3≦K+N≦P, and 1≦K−N≦(P−2).

According to an embodiment of the invention, the touch sensing system further includes a plurality of signal sensing units. In the step of selecting the signal under test, at least two sensing signals are selected as the signal under tests. In the step of selecting the reference signal, at least two sensing signals are selected from the unselected sensing signals as the reference signal. In the step of generating the difference signal according to the signal under test and the reference signal, the corresponding signal under test and the corresponding reference signal are received by using each signal sensing unit, so as to output the corresponding difference signal.

According to an embodiment of the invention, the corresponding signal under test received by each signal sensing unit is different from the corresponding signal under tests received by other signal sensing units.

According to an embodiment of the invention, each signal sensing unit receives the same corresponding signal under test during a first sensing period and a second sensing period.

According to an embodiment of the invention, each signal sensing unit receives different reference signals during the first sensing period and the second sensing period.

According to an embodiment of the invention, in the step of determining the position of the touch gesture on the touch input interface, the position of the touch gesture on the touch input interface is determined according to a plurality of difference signals.

According to an embodiment of the invention, the touch sensing method further includes generating a driving signal for driving the touch sensors to output the sensing signals.

As described above, in the embodiments of the invention, the signal selecting unit selects at least one reference signal from a plurality of sensing signals as a reference for measuring the signal under test, such that noises can be effectively reduced and the NSR of the touch sensing system can be enhanced. In addition, the signal selecting unit selects different reference signals during different sensing periods, so that the reference signal can be dynamically selected.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a touch sensing system according to an embodiment of the invention.

FIG. 2 is a circuit diagram of a touch input interface in FIG. 1.

FIG. 3 is a block diagram of a touch sensing system according to another embodiment of the invention.

FIG. 4 is a block diagram of a touch sensing system according to yet another embodiment of the invention.

FIG. 5 illustrates that a signal selecting unit selects different sensing signals during different sensing periods and sends the selected sensing signals to a corresponding signal sensing unit as reference signals.

FIG. 6 illustrates that a signal selecting unit selects different sensing signals during different sensing periods and sends the selected sensing signals to a corresponding signal sensing unit as reference signals.

FIG. 7 is a flowchart of a touch sensing method according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In a capacitive touch input interface, capacitance of a sensing capacitor is determined on whether a position of the sensing capacitor correspondingly on the touch input interface is touched. When the position of the sensing capacitor correspondingly on the touch input interface is touched, capacitance variation is induced by the touch object accordingly, such that a capacitance under test is generated by the touch object and the sensing capacitor.

According to the embodiments of the invention, except for the aforesaid capacitance under test, other capacitances of sensing capacitors can serve as reference values for measuring the capacitance under test. Hence, after the capacitance under test and the reference capacitance are compared, the touch position of the touch object correspondingly on the touch input interface can be determined.

In the embodiments provided hereinafter, a touch panel exemplarily acts as the touch input interface, while people having ordinary skill in the art are aware that the touch panel does not pose a limitation on the touch input interface of the invention. Meanwhile, the invention is not limited to the touch input interface. Any input interface capable of sensing capacitance variations does not depart from the protection scope of the invention.

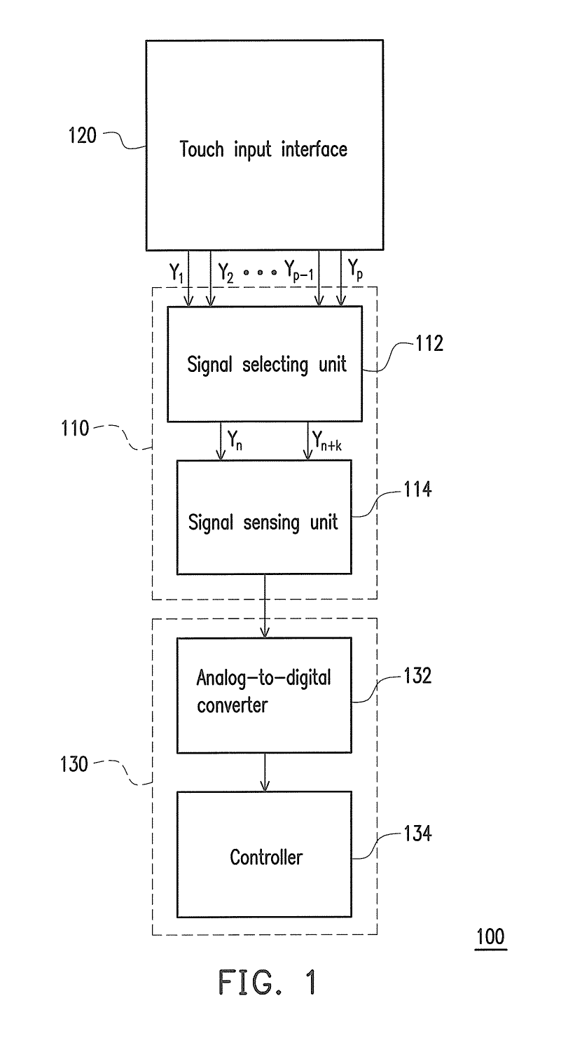

FIG. 1 is a block diagram of a touch sensing system according to an embodiment of the invention. Referring to FIG. 1, in the present embodiment, the touch sensing system 100 includes a capacitance sensing apparatus 110, a touch input interface 120, and a control unit 130. The touch input interface 120 may be a touch panel of a display or a touch pad with touch sensing capability. The touch input interface 120 includes a plurality of sensing capacitors for outputting a plurality of sensing signals Y₁-Yₚ.

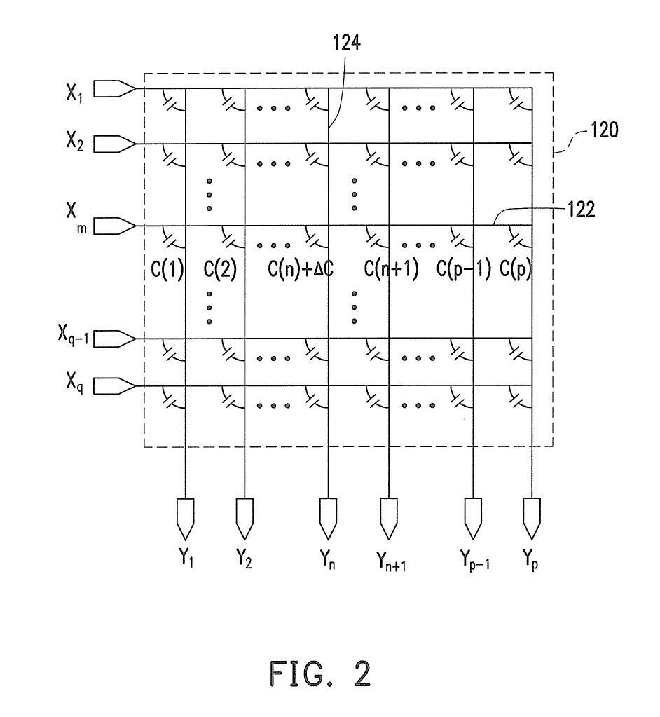

FIG. 2 is a circuit diagram of the touch input interface 120 in FIG. 1. Referring to both FIG. 1 and FIG. 2, in the present embodiment, the capacitance of a sensing capacitor is determined according to whether the corresponding position of the sensing capacitor on the touch input interface is touched. Taking the sensing capacitor C(n) as an example, when the corresponding position of the sensing capacitor C(n) on the touch input interface is touched, the touch object produces a corresponding capacitance variation ΔC. Then, a capacitor under test C(n)+ΔC is formed by the sensing capacitor C(n) and the capacitance variation ΔC, and a signal under test Yₙ is output through a corresponding sensing line 124. Next, the capacitance variation of the capacitor under test C(n)+ΔC is sensed by the capacitance sensing apparatus 110. After that, the control unit 130 determines the corresponding touch position of the capacitor under test on the touch input interface according to the capacitance variation. Namely, the control unit 130 determines the position of the touch gesture on the touch input interface 120 according to the capacitance variation.

It should be noted that in the present embodiment, the capacitances of other sensing capacitors except for the capacitor under test C(n)+ΔC can be served as reference signals for measuring the capacitance under test, so that external noises can be effectively reduced and the noise-to-signal ratio (NSR) of the touch sensing system can be enhanced.

To be specific, taking a mutual-capacitance touch sensing system as an example, when the touch sensing system is in operation, the capacitor under test of the touch input interface 120 receives driving signals X₁-X_{q} from a driving unit (not shown) through the corresponding driving line and then generates the sensing signals Y₁-Yₚ on the corresponding sensing line, wherein p and q are positive integers, 1<p, and 1<q. For example, when the touch input interface 120 is driven, the driving signal Xₘ supplied to the driving line 122 is coupled to the crossing sensing line 124 through the sensing capacitor C(n), so that the sensing signal Yₙ is generated on the sensing line 124, wherein n and m are positive integers, 1≦n≦p, and 1≦m≦q.

Thus, during the operation of the touch sensing system, the capacitance sensing apparatus 110 can obtain the capacitance distribution of the sensing capacitors C(1)-C(p) by supplying the driving signal Xₘ to the driving line 122.

Thereby, when a touch object (for example, a finger or a stylus) approaches or touches the corresponding position of the sensing capacitor C(n) on the touch input interface 120, a corresponding capacitance variation ΔC is produced and accordingly the capacitance distribution is changed. After that, the touch sensing system 100 determines the corresponding position of the capacitor under test C(n)+ΔC on the touch input interface 120 through the capacitance sensing apparatus 110 and the control unit 130.

Referring to FIG. 1 again, in the present embodiment, the capacitance sensing apparatus 110 includes a signal selecting unit 112 and a signal sensing unit 114. The control unit 130 includes an analog-to-digital converter (ADC) 132 and a controller 134.

The signal selecting unit 112 receives the sensing signals Y₁-Yₚ and selects at least one signal under test and at least one reference signal from the sensing signals Y₁-Yₚ. After that, the signal selecting unit 112 transmits the signal under test and reference signal to the signal sensing unit 114 to compare the difference.

For example, during a first sensing period, the signal selecting unit 112 transmits the sensing signals Yₙ and Yₙ₊ₖ to the signal sensing unit 114 to compare the difference. Herein k is a positive integer, 1≦n≦(p−1), and 2≦(n+k)≦p. Assuming k=1, the signal selecting unit 112 selects the sensing signal Yₙ₊₁ next to the sensing signal Yₙ as the reference signal for measuring the capacitor under test and outputs the sensing signal Yₙ₊₁ to the signal sensing unit 114 to be compared with the sensing signal Yₙ. Next, the signal sensing unit 114 generates a difference signal after it compares foregoing two signals and outputs the difference signal to the control unit 130. Namely, the control unit 130 determines the position of the touch gesture on the touch input interface 120 according to the difference signal.

Thus, in the present embodiment, the signal selecting unit 112 selects a sensing signal Yₙ₊ₖ from the unselected sensing signals (excluding the signal under test Yₙ) as the reference signal for measuring the capacitor under test, so that noises from the touch input interface 120 can be effectively reduced and the NSR of the touch sensing system can be enhanced.

In other words, noises on the touch input interface 120 can be considered as common mode noises. Thus, common mode noises in a sensing circuit can be restrained, so as to enhance the NSR of the touch sensing system, by selecting at least one sensing signal from the unselected sensing signals as a reference signal for measuring the capacitor under test.

It should be noted that in the present embodiment, the signal selecting unit 112 selects the sensing signals Yₙ and Yₙ₊ₖ. However, the invention is not limited thereto, and in other embodiments, the signal selecting unit 112 can select any sensing signal Yₘ (not shown) from the unselected sensing signals as the reference signal for measuring the capacitor under test, so as to reduce noises from the touch input interface 120, wherein 1≦m≦p.

Thus, during the first sensing period, when the sensing capacitor C(n) is touched and accordingly produces a capacitance variation ΔC, the control unit 130 determines the corresponding position of the touch gesture on the touch input interface 120 according to the difference signal generated by the signal sensing unit 114.

During a second sensing period following the first sensing period, the signal selecting unit 112 transmits the sensing signals Yₙ and Yₙ₋ₖ (not shown) to the signal sensing unit 114 to compare the difference, wherein 2≦n≦p and 1≦(n−k)≦(p−1). For example, k=1 indicates that the signal selecting unit 112 selects the sensing signal Yₙ₋₁ next to the sensing signal Yₙ as the reference signal for measuring the capacitor under test.

Namely, as to the same sensing signal Yₙ, the signal selecting unit 112 selects different sensing signals (i.e., the sensing signals Yₙ₊ₖ and Yₙ₋ₖ) from the unselected sensing signals as the reference signal for measuring the capacitor under test during consecutive sensing periods, so as to achieve a dynamic selection of the reference signal.

It should be noted that during the consecutive sensing periods, the signal selecting unit 112 does not have to select the symmetrical sensing signals Yₙ₊ₖ and Yₙ₋ₖ as the reference signal for measuring the capacitor under test. Instead, the signal selecting unit 112 simply selects different sensing signals from the unselected sensing signals as the reference signal for measuring the capacitor under test during the consecutive sensing periods.

In other embodiments, as to the same sensing signal Yₙ, the signal selecting unit 112 may also select the same sensing signal from the unselected sensing signals as the reference signal for measuring the capacitor under test during the consecutive sensing periods.

In the present embodiment, the signal sensing unit 114 may be a comparator (not shown) for receiving and comparing the signal under test and the reference signal output by the signal selecting unit 112, so as to generate the corresponding difference signal for the control unit 130. However, the invention is not limited thereto, and in another embodiment, the signal sensing unit 114 may be a differential amplifier. In this case, the signal sensing unit 114 compares and amplifies the voltage difference between the signal under test and the reference signal and outputs the voltage difference to the control unit 130, so as to increase the precision in determining the touch position. Additionally, in another embodiment, the signal sensing unit 114 may also be an integrator. In this case, the integrator integrates and amplifies the voltage difference between the signal under test and the reference signal so as to output the corresponding difference signal to the control unit 130.

In the present embodiment, the difference signal generated by the signal sensing unit 114 may be an analog signal. Thus, after receiving the analog signal, the ADC 132 converts it into a digital signal. Then, the controller 134 performs a digital operation on the digital signal to obtain the touch position corresponding to the capacitor under test C(n)+ΔC on the touch input interface 120. Namely, the controller 134 determines the position of the touch gesture on the touch input interface 120 according to the difference signal.

It should be noted that in the present embodiment, the touch sensing system 100 is a mutual-capacitance touch sensing system. However, the invention is not limited thereto, and in other embodiments, the touch sensing system 100 may also be a self-capacitance touch sensing system or any other type of touch sensing system.

Additionally, in the present embodiment, the signal selecting unit 112 selects one of sensing signal from the unselected sensing signals as the reference signal for measuring the capacitor under test. In another embodiment, the signal selecting unit 112 may also select two sensing signals from the unselected sensing signals as reference signals for measuring the capacitor under test.

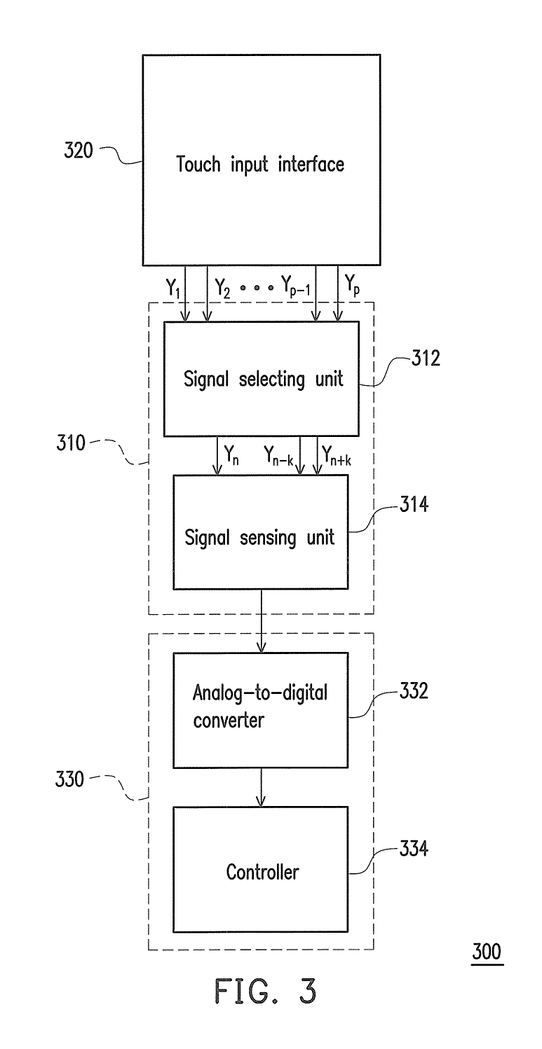

FIG. 3 is a block diagram of a touch sensing system according to another embodiment of the invention. Referring to FIG. 3, in the present embodiment, the signal selecting unit 312 selects two sensing signals from the unselected sensing signals as the reference signals for measuring the capacitor under test during a third sensing period. For example, the signal selecting unit 312 selects the sensing signals Yₙ₊ₖ and Yₙ₋ₖ during the third sensing period as the reference signals for measuring the capacitor under test. k=1 indicates that the signal selecting unit 312 selects two sensing signals Yₙ₊₁ and Yₙ₋₁ next to the sensing signal Yₙ as the reference signals for measuring the capacitor under test.

It should be noted that the signal selecting unit 312 is not limited to selecting the symmetrical sensing signals Yₙ₊ₖ and Yₙ₋ₖ as the reference signals for measuring the capacitor under test during the same sensing period. Instead, the signal selecting unit 312 can select any two different sensing signals from the unselected sensing signals as the reference signals for measuring the capacitor under test.

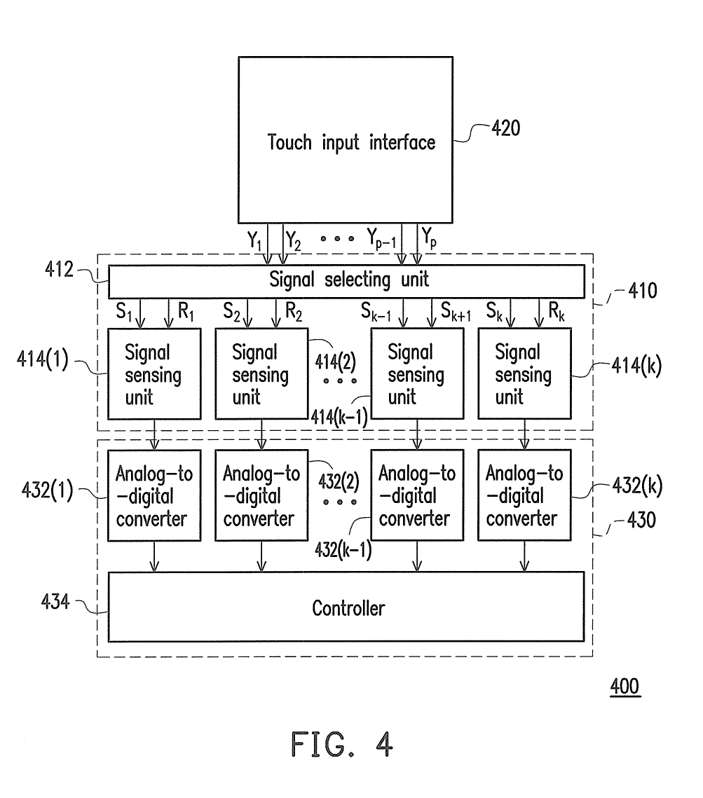

FIG. 4 is a block diagram of a touch sensing system according to yet another embodiment of the invention. Referring to FIG. 4, in the present embodiment, the object sensing apparatus 410 includes a signal selecting unit 412 and a plurality of signal sensing units 414(1)-414(k). The control unit 430 includes a plurality of ADCs 432(1)-432(k) and a controller 434, wherein k=p/2 when p is an even number.

In the present embodiment, the signal selecting unit 412 selects a plurality of signals from the sensing signals Y₁-Yₚ as signal under tests S₁-Sₖ and selects a plurality of signals from the rest sensing signals as reference signals R₁-Rₖ, and each of the signal sensing units receives a signal under test and a reference signal to output a difference signal to the corresponding ADC.

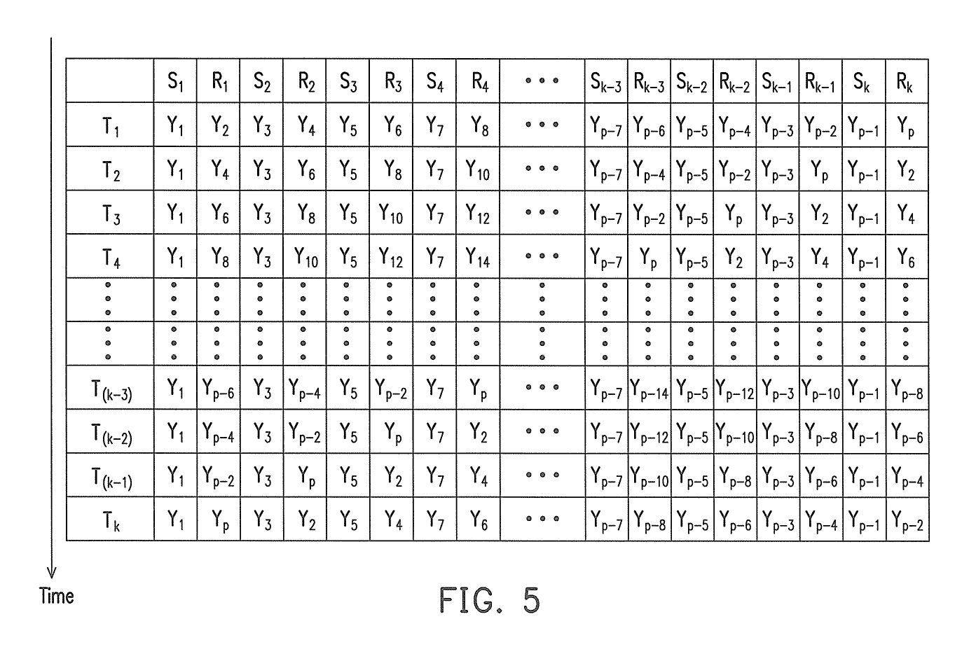

FIG. 5 illustrates that the signal selecting unit 412 selects different sensing signals during different sensing periods T₁-Tₖ and transmits the selected sensing signals to the corresponding signal sensing unit as reference signals. Referring to FIG. 5, the first column represents the sensing periods T₁-Tₖ, and the first row represents the signal under tests or reference signals corresponding to each column. For example, the second row represents that the signal selecting unit 412 selects the sensing signal Y₁ as the signal under test S₁ and transmits the signal under test S₁ to the signal sensing unit 414(1) during the sensing periods T₁-Tₖ, and the third row represents that the signal selecting unit 412 respectively selects the sensing signals Y₂, Y₄, . . . , and Yₚ as the reference signal R₁ and transmits the reference signal R₁ to the signal sensing unit 414(1) during different sensing periods.

As shown in FIG. 4 and FIG. 5, in the present embodiment, as to the signal under tests S₁-Sₖ, the signal sensing units receive different signal under tests. For example, during the sensing periods T₁-Tₖ, the signal under test S₁ received by the signal sensing unit 414(1) is the sensing signal Y₁, and the signal under test S₂ received by the signal sensing unit 414(2) is the sensing signal Y₃. In addition, the same signal sensing unit receives the same signal under test during different sensing periods. For example, the signal sensing unit 414(1) always receives the sensing signal Y₁ as the signal under test S₁ during different sensing periods.

In addition, in the present embodiment, as to the reference signals R₁-Rₖ, the same signal sensing unit receives different reference signals during different sensing periods. For example, the signal sensing unit 414(1) sequentially receives the sensing signals Y₂, Y₄, . . . , and Yₚ as the reference signal R₁ during different sensing periods, and the signal sensing unit 414(2) sequentially receives the sensing signals Y₄, Y₆, . . . , Yₚ, and Y₂ as the reference signal R₂ during different sensing periods.

Thus, during the sensing periods T₁-Tₖ, the signal sensing unit 414(1) respectively compares the sensing signal Y₁ with the sensing signals Y₂, Y₄, . . . , and Yₚ to sequentially output the corresponding difference signals to the ADC 432(1). Similarly, during the sensing periods T₁-Tₖ, the signal sensing unit 414(2) respectively compares the sensing signal Y₃ with the sensing signals Y₄, Y₆, . . . , Yₚ, and Y₂ to sequentially output the corresponding difference signals to the ADC 432(2).

Thus, the controller 434 performs a digital operation on a plurality of digital signals received during each sensing period so as to obtain the touch position corresponding to the capacitor under test on the touch input interface 420. Namely, the controller 434 determines the position of the touch gesture on the touch input interface 420 according to the difference signal.

Accordingly, in the present embodiment, each signal sensing unit of the touch sensing system 400 receives a signal under test and a reference signal so that noises from the touch input interface 420 can be effectively reduced and the NSR of the touch sensing system 400 can be enhanced. Meanwhile, as to each signal sensing unit, the signal selecting unit 412 selects different sensing signals during different sensing periods and transmits the sensing signals to the corresponding signal sensing units as the reference signals, so that a dynamic selection of the reference signal is achieved.

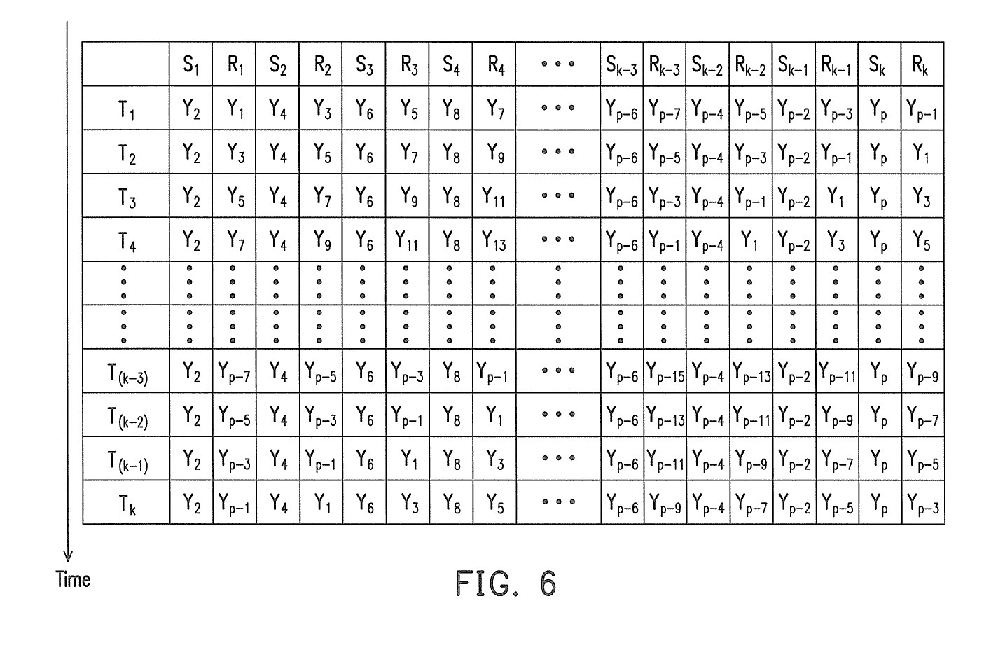

It should be noted that the selection of the signal under test and the reference signal illustrated in FIG. 5 is only an exemplary embodiment of the invention but not intended to limit the scope of the invention. FIG. 6 illustrates different selecting methods of the signal selecting unit 412 during different sensing periods according to another exemplary embodiment of the invention.

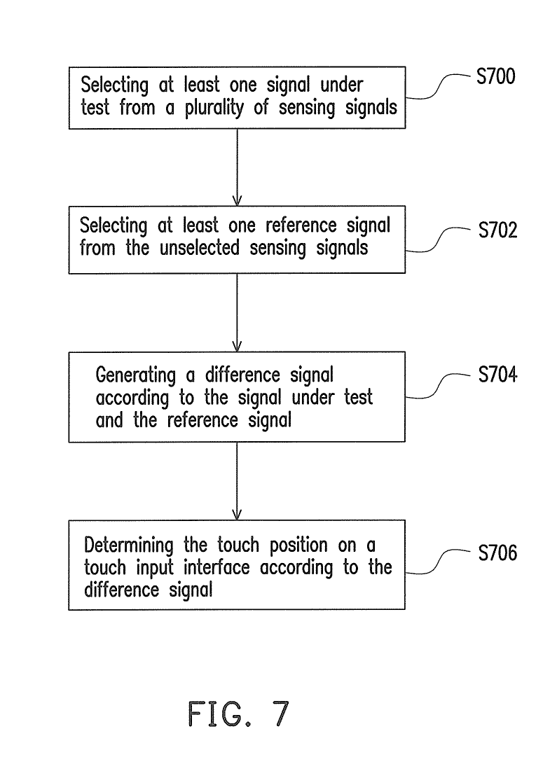

FIG. 7 is a flowchart of a touch sensing method according to an embodiment of the invention. Referring to both FIG. 1 and FIG. 7, the touch sensing method in the present embodiment includes following steps. First, in step S700, at least one signal under test is selected from a plurality of sensing signals. For example, a signal under test Yₙ is selected from the sensing signals Y₁-Yₚ. Then, in step S702, at least one reference signal is selected from the rest sensing signals. For example, a reference signal Yₘ is selected from the rest sensing signals. Next, in step S704, a difference signal is generated according to the signal under test Yₙ and the reference signal Yₘ. After that, in step S706, the position of a touch gesture on the touch input interface is determined according to the difference signal.

Additionally, the touch sensing method in embodiments of the invention can be understood and implemented according to the descriptions of the embodiments illustrated in FIGS. 1-6 therefore will not be further described herein.

Furthermore, even though the object sensing apparatus is described as a touch sensing system in the embodiments of the invention, the invention is not limited thereto. Any object sensing apparatus that can sense and determine the position of an object can be applied to the invention.

As described above, in the embodiments of the invention, the signal selecting unit selects at least one reference signal from a plurality of sensing signals as a reference for measuring the signal under test, such that noises can be effectively reduced and the NSR of the touch sensing system can be enhanced. In addition, the signal selecting unit selects different reference signals during different sensing periods, so that the reference signal can be dynamically selected.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An object sensing apparatus, comprising:
an object sensing unit outputting a plurality of sensing signals;
a signal selecting unit selecting at least one of the sensing signals as a signal under test and selecting at least one of the unselected sensing signals as a reference signal;
at least one signal sensing unit outputting a difference signal according to the signal under test and the reference signal; and
a control unit determining an object position relative to the object sensing unit according to the difference signal.

2. The object sensing apparatus according to claim 1, wherein the control unit comprises:
an analog-to-digital converter (ADC) converting the difference signal into a digital signal; and
a controller determining the object position relative to the object sensing unit according to the digital signal.

3. The object sensing apparatus according to claim 1, wherein the signal selecting unit respectively selects at least two different sensing signals from the unselected sensing signals as the reference signal during a first sensing period and a second sensing period.

4. The object sensing apparatus according to claim 1, wherein a number of the sensing signals is P, and the signal selecting unit selects the N^{th} sensing signal as the signal under test and selects the (N+K)^{th} sensing signal and the (N−K)^{th} sensing signal as the reference signal, wherein P, N, and K are positive integers, 1<N<P, 3≦K+N≦P, and 1≦K−N≦(P−2).

5. The object sensing apparatus according to claim 1, wherein the signal selecting unit selects at least two of the sensing signals as the signal under tests and selects at least two of the unselected sensing signals as the reference signals, and each of the signal sensing units receives the corresponding signal under test and the corresponding reference signal to output the corresponding difference signal.

6. The object sensing apparatus according to claim 5, wherein the corresponding signal under test received by each of the signal sensing units is different from the corresponding signal under tests received by the rest signal sensing units.

7. The object sensing apparatus according to claim 5, wherein each of the signal sensing units receives the same corresponding signal under test during a first sensing period and a second sensing period.

8. The object sensing apparatus according to claim 7, wherein each of the signal sensing units receives the different reference signal during the first sensing period and the second sensing period.

9. The object sensing apparatus according to claim 5, wherein the control unit receives the difference signals and determines the object position relative to the object sensing apparatus according to the difference signals.

10. The object sensing apparatus according to claim 9, wherein the control unit comprises:
a plurality of ADCs, each of the ADCs receiving the corresponding difference signal and converts the corresponding difference signal into a corresponding digital signal; and
a controller receiving the digital signals and determining the object position relative to the object sensing apparatus according to the digital signals.

11. The object sensing apparatus according to claim 1 further comprising:
a driving unit, for driving the object sensing unit to output the sensing signals.

12. A touch sensing system, comprising:
a touch input interface comprising a plurality of touch sensors, and the touch sensors outputting a plurality of sensing signals according to a touch gesture;
a signal selecting unit selecting at least one of the sensing signals as a signal under test and selecting at least one of the unselected sensing signals as a reference signal;
at least one signal sensing unit, for outputting a difference signal according to the signal under test and the reference signal; and
a control unit determining a position of the touch gesture on the touch input interface according to the difference signal.

13. The touch sensing system according to claim 12, wherein the control unit comprises:
an ADC converting the difference signal into a digital signal; and
a controller determining the position of the touch gesture on the touch input interface according to the digital signal.

14. The touch sensing system according to claim 12, wherein the signal selecting unit respectively selects at least two different sensing signals from the unselected sensing signals as the reference signal during a first sensing period and a second sensing period.

15. The touch sensing system according to claim 12, wherein a number of the sensing signals is P, and the signal selecting unit selects the N^{th} sensing signal as the signal under test and selects the (N+K)^{th} sensing signal and the (N−K)^{th} sensing signal as the reference signal, wherein P, N, and K are positive integers, 1<N<P, 3≦K+N≦P, and 1≦K−N≦(P−2).

16. The touch sensing system according to claim 12, wherein the signal selecting unit selects at least two of the sensing signals as the signal under tests and selects at least two of the unselected sensing signals as the reference signals, and each of the signal sensing units receives the corresponding signal under test and the corresponding reference signal to output the corresponding difference signal.

17. The touch sensing system according to claim 16, wherein the corresponding signal under test received by each of the signal sensing units is different from the corresponding signal under tests received by the rest signal sensing units.

18. The touch sensing system according to claim 16, wherein each of the signal sensing units receives the same corresponding signal under test during a first sensing period and a second sensing period.

19. The touch sensing system according to claim 18, wherein each of the signal sensing units receives the different reference signal during the first sensing period and the second sensing period.

20. The touch sensing system according to claim 16, wherein the control unit receives the difference signals and determines the position of the touch gesture on the touch input interface according to the difference signals.

21. The touch sensing system according to claim 20, wherein the control unit comprises:
a plurality of ADCs, each of the ADCs receiving the corresponding difference signal and converts the corresponding difference signal into a corresponding digital signal; and
a controller receiving the digital signals and determining the position of the touch gesture on the touch input interface according to the digital signals.

22. The touch sensing system according to claim 12 further comprising:
a driving unit, for driving the touch sensors to output the sensing signals.

23. A touch sensing method, adapted to a touch sensing system, wherein the touch sensing system comprises a touch input interface, the touch sensing method comprising:
generating a plurality of sensing signals according to a touch gesture;
selecting at least one of the sensing signals as a signal under test;
selecting at least one of the unselected sensing signals as a reference signal;
generating a difference signal according to the signal under test and the reference signal; and
determining a position of the touch gesture on the touch input interface according to the difference signal.

24. The touch sensing method according to claim 23 further comprising:
converting the difference signal into a digital signal; and
determining the position of the touch gesture on the touch input interface according to the digital signal.

25. The touch sensing method according to claim 23, wherein in the step of selecting the reference signal, at least two different sensing signals are respectively selected from the unselected sensing signals as the reference signal during a first sensing period and a second sensing period.

26. The touch sensing method according to claim 23, wherein a number of the sensing signals is P, in the step of selecting the signal under test, the N^{th} sensing signal is selected as the signal under test, and in the step of selecting the reference signal, the (N+K)^{th} sensing signal and the (N−K)^{th} sensing signal are selected as the reference signal, wherein P, N, and K are positive integers, 1<N<P, 3≦K+N≦P, and 1≦K−N≦(P−2).

27. The touch sensing method according to claim 23, wherein the touch sensing system further comprises a plurality of signal sensing units, in the step of selecting the signal under test, at least two of the sensing signals are selected as the signal under tests, in the step of selecting the reference signal, at least two of the unselected sensing signals are selected as the reference signals, and in the step of generating the difference signal according to the signal under test and the reference signal, the corresponding signal under test and the corresponding reference signal are received by using each of the signal sensing units, so as to output the corresponding difference signal.

28. The touch sensing method according to claim 27, wherein the corresponding signal under test received by each of the signal sensing units is different from the corresponding signal under tests received by the unselected signal sensing units.

29. The touch sensing method according to claim 27, wherein each of the signal sensing units receives the same corresponding signal under test during a first sensing period and a second sensing period.

30. The touch sensing method according to claim 29, wherein each of the signal sensing units receives the different corresponding reference signal during the first sensing period and the second sensing period.

31. The touch sensing method according to claim 27, wherein in the step of determining the position of the touch gesture on the touch input interface, the position of the touch gesture on the touch input interface is determined according to the difference signals.

32. The touch sensing method according to claim 23 further comprising:
generating a driving signal to drive the touch sensors to output the sensing signals.
